(19) United States
(12) Patent Application Publication
(10) Pub. No.: US 2010/0285199 A1
(43) Pub. Date: Nov. 11, 2010

(54) SUGAR-FREE JELLY COMPRISING GELATIN

(75) Inventors: Seok Yoon, Seoul (KR); Chang Hoon Kang, Seoul (KR); Man Chong Lee, Gyeonggi-do (KR); Yong Tack Kim, Seoul (KR)

Correspondence Address: LOWE HAUPTMAN HAM & BERNER, LLP, 1700 DIAGONAL ROAD, SUITE 300, ALEXANDRIA, VA, 22314, US

(73) Assignee: LOTTE CONFECTIONERY CO., LTD., Seoul (KR)

(21) Appl. No.: 12/746,457

(22) PCT Filed: Dec. 4, 2008
(86) PCT No.: PCT/KR2008/007162

§ 371 Date: Jun. 4, 2010

(30) Foreign Application Priority Data
Dec. 5, 2007 (KR) 10-2007-0125757

(51) Int. Cl. A23L 1/06; A23L 1/09

(52) U.S. Cl. 426/576

(57) ABSTRACT

The present invention relates to a sugar-free jelly composition using gelatin, more specifically, a sugar-free jelly composition obtained by replacing sugars such as sugar, fructose, and starch syrup used for manufacturing a conventional jelly with sugar alcohols and mixing them in a suitable mixing ratio for the prevention and treatment of obesity, diabetes, and tooth decay as well as maintaining the sweetness and the quality contained in the conventional sugar jellies.

### TECHNICAL FIELD

The present invention relates to a sugar-free jelly composition using gelatin, more specifically, a sugar-free jelly composition obtained by replacing sugars such as sugar, fructose, and starch syrup used for manufacturing a conventional jelly with sugar alcohols and mixing them in a suitable mixing ratio for the prevention and treatment of obesity, diabetes, and tooth decay as well as maintaining the sweetness and the quality contained in the conventional sugar jellies.

### BACKGROUND ART

With the increasing consumers' interest on new healthy foods, there has been a rapid increase in demand for a new healthy food not containing high calori food including sugars such as high calorie sugar, and glucose syrup, causing diabetes and tooth decay while maintaining sweetness contained in the conventional foods.

To meet the above, sugar alcohols including xylitol, sorbitol, maltitol (C₁₂H₂₄O₁₁), maltotritol, lactitol(1,4-galgctosyl-glucitol), mannitol (C₆H₁₄O₆), isomalt, maltitol syrup (reduced maltose glucose syrup), polyglycitol Syrup (reduced glucose syrup) have been widely used as a substitute for the sugars such as sugar, fructose, glucose syrup and various foods containing sugar alcohols instead of conventional sugars are being manufactured and sold.

Conventionally, sugars include sugar, glucose, fructose, taffies, sugar syrups, dextrin, oligosaccharide obtained by processing a raw starch material or sucrose syrup. A polysaccharide is a sugar consisting of multiple monosaccharides formed by a glycosidic bond, especially with 3-8 monosaccharides are called an oligosaccharide. Sugar alcohols prepared by reacting sugars via hydrogenation at high temperature under high pressure, and the sugar alcohols also can be called hydrogenated sugars, polyol, etc. Generally, those containing maltitol with a content of 50% or higher are called maltitol syrup, and those with a content less than 50% are called polyglycitol. Polyglycitol has a higher degree of polymerization than maltitol syrup thus suggesting that it is a sugar alcohol having a greater average molecular weight.

Isomalt is a little hygroscopic white crystal having a sweetness of 0.45 relative to that of sugar, having a similar taste to sugar having a fresh taste without any aftertaste, which can be used as a substitute for confectionery, gums, and cooling drinks with less calories than sugar while being less likely to induce diarrhea than xylitol or sorbitol. Especially, unlike glucose, it gives little effect on the level of blood sugar, and is thus suitable for a sugar substitute for patients with diabetes.

Generally, a jelly using gelatin as the main gelling agent contains 10-15% of water and thus has a relatively high elasticity; a jelly using pectin as the main gelling agent becomes crispy in the presence of an acid; and a jelly using carrageenan or konjac as the main gelling agent has 50-80% of water content so that it can provide soft food taste and elasticity.

For a large scale manufacture of sugar-free jelly containing a sugar alcohol instead of sugar, it is essential to determine the optimum mixing ratio of the components contained in the jelly so that similar physical properties (e.g., viscosity) as in sugar-containing jellies can be provided and also quality deterioration due to hygroscopicity and recrystallization of jelly can be prevented. However, obtaining the optimum mixing ratio is not an easy task and it thus has been an obstacle in the large scale manufacture of sugar-free jelly.

### DETAILED DESCRIPTION OF INVENTION

### Technical Problem

As a result of intensive researches to resolve the above problems for the manufacture of a sugar-free jelly, the inventors of the present invention discovered a method for a large scale production of jelly, where saccharide is replaced by a sugar alcohol, by adding a sugar alcohol in an optimal mixing ratio and also using gelatin as a gelling agent.

Therefore, an object of the present invention is to provide a sugar-free jelly composition having the sweetness and texture of the conventional jellies while maintaining low calories, and preventing tooth decay to meet the recent consumers' well-being trend for good health.

### Technical Solution

The present invention relates to a sugar-free jelly composition prepared by using a sugar alcohol, comprising 3.0-10.0 parts by weight of gelatin relative to 100 parts by weight of a raw sugar material comprising 50-90 wt. % of polyglycitol and 10-50 wt. % of maltitol syrup.

### Advantageous Effects

The present invention relates to a sugar-free jelly, prepared by using a sugar alcohol such as xylitol, maltitol, sorbitol, and isomalt, instead of the sugars such as sugar. More specifically, the jelly according to the present invention maintains sweetness and quality of the conventional jellies as well as contains low calories so that it can protect consumers' health by preventing obesity and tooth decay reducing the medical cost incurring as a result of health problems due to sugar intake.

### Best Mode

As consumers are more concerned about their health than ever before with the recent well-being health trend on sugar-free foods, there is an increasing demand for sugar-free jelly among jelly lovers. However, for the manufacture of sugar-free jelly containing a sugar alcohol instead of sugar, it is necessary to obtain the optimum mixing ratio of the jelly components so that similar physical properties (e.g., viscosity) as in sugar-containing jellies can be attained and also quality deterioration due to hygroscopicity and recrystallization of jelly can be prevented. However, obtaining the optimum mixing ratio is not an easy task and it thus has been an obstacle in the large scale manufacture of sugar-free jelly.

Therefore, the inventors of the present invention have performed extensive researches to obtain a sugar-free jelly composition and finally succeeded in preparing a sugar-free jelly composition.

The present invention relates to a jelly added with sugar alcohols instead of saccharide as described hereinbelow.

The present invention relates to a sugar-free jelly composition comprising 3-10 parts by weight of gelatin relative to 100 parts by weight of a raw sugar material, which comprises 50-90 wt. % of polyglycitol and 10-50 wt. % of maltitol syrup. Generally, maltitol syrup contains more than 50% of maltitol, while polyglycitol contains less than 50% of maltitol. Because the degree of polymerization of polyglycitol is higher than that of maltitol syrup, polyglycitol is categorized as a sugar alcohol having a higher average molecular weight.

In the present invention, maltitol syrup and polyglycitol are defined separately as well.

The ingredients of the present invention will be more specifically described herein after.

Maltitol is a sweetener having 75-95% of sweetness relative to that of sugar. While sugar is directly digested by intrinsic enzymes and absorbed therefrom into the body to be used as an energy source, maltitol, being decomposed by enterobacteria, is mostly (70-90%) excreted out of the body and only a small amount is absorbed in the body, and is thus regarded as a low calorie substance.

Further, maltitol has a sweetener having insulin-independence, anti-acid property, heat resistance, and it hardly produces organic acids such as lactic acid or pyruvic acid generated by bacteria inside the oral cavity and thus it is effective for the prevention of tooth decay.

Also, maltitol has an excellent effect of lowering water activity, it is hardly utilized by microorganisms unlike glucose syrup. Further, it has superior capabilities of maintaining freshness of foods, preserving the quality of dried fish during the process. Also, maltitol, when used in foods and beverages, can increase density by increasing viscosity and reduce generation of crystals in sugar.

Sorbitol has low sweetness and has the effects of preventing protein denaturation, adjusting moisture content, and long preserving of flavors of foods and beverages.

According to the present invention, if the polyglycitol is less than 50 wt. %, the jellies recrystalize rapidly and their texture deteriorate accordingly. In contrast, if it is greater than 90 wt. %, it becomes too sticky to eat by adhering to teeth.

Preferably, polyglycitol has 500-700 of average molecular weight, more preferably 600-670. Polyglycitol comprises 7-10 wt. % of maltitol, 3-5wt. % of sorbitol, 10-15 wt. % of maltotritol, and 70-80 wt. % of sugar alcohols, wherein the sugar alcohols preferably has a degree of polymerization not lower than 4. If the average molecular weight of the polyglycitol is less than 500, the elasticity of jelly is decreased. On the contrary, if it is greater than 700, the resulting jelly becomes very hard and its taste deteriorates.

If the maltitol is contained less than 7 wt. %, its sweetness becomes decreased. Meanwhile, if it is contained more than 10 wt. %, the texture denaturation of jelly may cause. If the sorbitol is contained less than 3 wt. %, sweetness becomes too low. Meanwhile, if it is contained more than 5 wt. %, the flavor becomes too strong. If the maltotritol is contained less than 10 wt. %, moisturizing effects get decreased. Meanwhile, if it is contained more than 15 wt. %, the contents of other ingredients are relatively reduced thereby causing other problems.

The average molecular weight of maltitol syrup is preferably 300-450, more preferably 350-400. The maltitol syrup comprises 70-75 wt. % of maltitol, 1-4 wt. % of sorbitol, 16-20 wt. % of maltotritol, and 5-8 wt. % of sugar alcohols. The sugar alcohols preferably have a degree of polymerization not lower than 4. If the average molecular weight of maltitol syrup is less than 300, the resulting jelly denaturates. Meanwhile, if it is greater than 450, the texture of jelly becomes deteriorated. Further, maltitol, an ingredient of maltitol syrup, is contained less than 70 wt. %, freshness gets worsened. Meanwhile, if it is contained more than 75 wt. %, the water activity is greatly reduced. If the maltotritol is contained less than 16 wt. %, moisturizing effect get deteriorated. Meanwhile, if it is contained more than 20 wt. %, the contents of other ingredients are relatively reduced thereby causing other problems.

Generally, edible jellies are produced by mixing sugar and glucose syrup as active ingredients with a gelling agent for sustaining the shape. The gelling agent is usually gelatin, pectin, carrageenan, konjac, agar, and CMC (Carboxy methyl cellulose).

A gelling agent affects the quality (texture) of the jelly according to its kind and heat resistance. Especially, according to the kind of a raw sugar material, the mixing rate varies depending on the mixing ratio of the jelly ingredients, and a gelling agent is directly associated with the formability and productivity of the jelly.

The present invention is characterized by using gelatin as a gelling agent, wherein gelatin is preferably used in the amount of 3-10 parts by weight relative to 100 parts by weight of the raw sugar material. If the gelatin is used less than 3.0 wt. %, an elastic jelly cannot be made. Meanwhile, if it is used more than 10.0 wt. %, the texture of jelly become too hard and too sticky to eat.

The jelly composition of the present invention may be prepared by adding at least one selected from the group consisting of gelatin, an acidulant, and a flavor relative to 100 parts by weight of the raw sugar material.

The acidulant may comprise at least one selected from the group consisting of citric acid, anhydrous citric acid, DL-malic acid, lactic acid, L-tartaric acid, succinic acid, vitamin C (L-ascorbic Acid), and fumaric acid.

The flavor may comprise at least one selected from the group consisting of apple, grape, and peach flavors.

The present invention may be further described with the examples herein after but the invention is not limited to the same.

### EXAMPLES

### Example 1

Gelatin (5.0 g), citric acid (0.8 g) as an acidulant, DL-malic acid (0.4 g), and apple flavor (0.3 g) were added relative to a raw sugar material (100 g) comprising 90 g of Polyglycitol30® (Samyang Genex Corp.), 10 g of maltitol syrupC® (Samyang Genex Corp.) to prepare a sugar-free jelly.

### Example 2

Example 2 was performed the same as in Example 1, except using a raw sugar material comprising polyglycitol (70 g) and maltitol syrup (30 g).

### Example 3

Example 3 was performed the same as in Example 1, except using polyglycitol (50 g) and maltitol syrup (50 g).

### Comparative Example 1

Comparative Example 1 was performed the same as in Example 1, except using polyglycitol (30 g) and maltitol syrup (70 g).

### Preparation of a Sugar-Free Jelly Without Using Polyglycitol

### Comparative Examples 2-4

Jelly was prepared by using the same maltitol syrup used in Example 1, the sugar alcohols with a polymerization degree of 1 and polymerization degree of 2. The sugar alcohols with polymerization degree of 2 used were xylitol, sorbitol, and maltitol, and the mixing ratio is shown in the following Table 1.

### Comparative Example 5

By using saccharides such as conventional sugar, a jelly was prepared by using gelatin (5 g), citric acid (0.8 g) as an acidulant, DL-malic acid (0.4 g), and an apple flavor (0.3 g) relative to a raw sugar material (100 g) comprising 44 g of white sugar (CJ, Korea), 45.8 g of glucose syrup (Hymaltose®, ShindongbangCP), 10 g of D-sorbitol (Samyang Genex Corp.), and 0.2 g of pectin (CP130B®, Danisco).

TABLE 1

| | | Comparative | Comparative | Comparative |
|---|---|---|---|---|
| Category | | Example 2 | Example 3 | Example 4 |
| Ingr. | xylitol (g) | 9.5 | 14.5 | 19.5 |
| | D-sorbitol (g) | 4.5 | 9.5 | 9.5 |
| | maltitol (g) | 9.5 | 5.0 | 9.5 |
| | maltitol syrup (g) | 76.5 | 71 | 61.5 |

| | |
|---|---|
| a raw sugar | 100 g |
| material | |
| gelatin | 5 g |
| acidulant | 1.2 g (citric acid (0.8 g), DL-malic acid (0.4 g)) |
| flavor | 0.4 parts by weight (apple flavor) |

Of the ingredients used:
1) maltitol syrup comprises maltitol (73.2 wt. %), sorbitol (1.9 wt. %), maltotritol (17.5 wt. %), maltotetraiol (6.4 wt. %), and other sugar alcohols (1 wt. %);
2) xylitol is the one manufactured by Danisco;
3) D-sorbitol is the one manufactured by Samyang Genex Corp;
4) gelatin is the one manufactured by Sammi Gelatin;
5) acidulant is citric acid manufactured by Roche; and
6) flavor is a grape flavor (KLH-12394) manufactured by Hasegawa flavor.

### Experimental Example

The jellies prepared in the Examples and Comparative Examples were tested via sensory test and shelflife test to evaluate the possibility of commercializing the present invention and the physical properties thereof, the Experimental Examples 1-4 and Comparative Experimental Examples 1-5 are shown in Table 2 respectively.

TABLE 2

| Category | sensory test | shelflife test |
|---|---|---|
| Experimental Example 1 | 4.4 | 4.3 |
| Experimental Example 2 | 4.3 | 4.2 |
| Experimental Example 3 | 4.0 | 4.0 |
| Comparative Experimental Example 1 | 3.5 | 2.3 |
| Comparative Experimental Example 2 | 3.8 | 2.2 |
| Comparative Experimental Example 3 | 3.8 | 1.5 |
| Comparative Experimental Example 4 | 3.5 | 1.0 |
| Comparative Experimental Example 5 | 4.7 | 4.5 |

The sensory evaluation of the above Table 2 evaluates teeth adhesiveness and chewing taste as overall taste performed by using 5 point scaling technique on sensory test, when the result of the sensory evaluation is higher than 4.0, the texture is considered good. Meanwhile, if it is in the range of 3.0-3.9, the texture is considered poor if it is less than 2.9.

According to the above Table 2, the jellies were stored at 35 with 55% of comparative humidity, and then analyzed for their colors, teeth adhesiveness, appearance, recrystalization, etc., for 30 days. If the result of shelflife test is less than 2.5, recrystalization precipitates rapidly, resulting in the texture deteriorations, thus commercialization becoming almost impossible. Meanwhile, if it is higher than 3.5, recrystalization is processed very slowly, maintaining the good texture thus the commercialization becoming possible.

Further, the Experimental Examples shown in the Table 2 revealed that in jellies prepared in the Comparative Examples 1-4 without using polyglycitol, the chewing taste of the jellies at the beginning of the preparation were similar to the jelly (Comparative Example 5) containing conventional saccharides, but because of the rapid recrystalization at the commercialization phase, their commercialization appears difficult.

The result of Comparative Example 1 using 30 wt. % of polyglycitol shows average sensory evaluation but not a good texture causing problems in commercialization. As a result, it is disclosed that polyglycitol is an indispensible ingredient of the sugar-free jelly composition of the present invention, and the content thereof is preferably more than 50 wt. %.

The Experimental Examples show that the sugar-free jelly prepared in the Examples 1-3 comprising 50-90 wt. % of polyglycitol syrup and 10-50 wt. % of maltitol syrup has superior texture, confirming that the jelly containing sugar alcohols replacing the conventional saccharides can be commercialized.

### INDUSTRIAL APPLICABILITY

The present invention relates to a sugar-free jelly and a preparation method thereof. Jellies have long been favored by men and women of all ages, but consumers' keen concerns about the risk of health problems caused by sugar jellies containing conventional sugars and glucose syrup, their sales have been much withdrawn. However, the sugar-free jelly of the present invention does not cause any health problems unlike the conventional jellies and are capable of preventing tooth decay by comprising as components sugar alcohols such as polyglycitol, maltitol syrup. The present invention enables a large scale production of sugar-free jellies leading to their commercialization, and the jellies prepared according to the present invention are expected to be actively used in the food and service industries.

1. A sugar-free jelly composition comprising 3-10 parts by weight of gelatin relative to 100 parts by weight of a raw sugar material consisting of 50-90 wt. % of polyglycitol and 10-50 wt. % of maltitol syrup.

2. The sugar-free jelly composition as claimed in claim 1, wherein the polyglycitol comprises 7-10 wt. % of maltitol, 3-5 wt. % of sorbitol, 10.0-15 wt. % of maltotritol, and 70-80 wt. % of sugar alcohols having a degree of polymerization not lower than 4.

3. The sugar-free jelly composition using gelatin as claimed in claim 1, wherein the maltitol syrup comprises 70-75 wt. % of maltitol, 1-4 wt. % of sorbitol, 16-20 wt. % of maltotritol, and 5-8 wt. % of sugar alcohols having a degree of polymerization not lower than 4.
